(19) United States
(12) Patent Application Publication
(10) Pub. No.: US 2019/0021345 A1
(43) Pub. Date: Jan. 24, 2019

(54) ARRANGEMENT FOR CLEANING BAKING SURFACES

(71) Applicant: HAAS FOOD EQUIPMENT GMBH, WIEN (AT)

(72) Inventors: JOHANNES HAAS, WIEN (AT); JOSEF HAAS, LEOBENDORF (AT); STEFAN JIRASCHEK, KOENIGSBRUNN (AT); MARTIN KALLER, PILLICHSDORF (AT); JOHANN SACHSENHOFER, WIEN (AT); BERHARD HAIDENBAUER, WIEN (AT)

(21) Appl. No.: 15/757,518

(22) PCT Filed: Sep. 2, 2016
(86) PCT No.: PCT/EP2016/070696

§ 371 Date: Mar. 5, 2018

(30) Foreign Application Priority Data
Sep. 3, 2015 (EP) 15183600.4

(51) Int. Cl. A21B 3/00; B08B 7/00; B08B 7/04; A21B 1/46; B23K 26/082; B23K 26/06; B23K 26/352

(52) U.S. Cl. CPC A21B 3/006; B08B 7/0042; B08B 7/04; B23K 26/352; B23K 26/082; B23K 26/0643; A21B 1/46

(57) ABSTRACT

A laser arrangement cleans baking surfaces configured in a relief-like manner and optionally cleans evaporation and/or sealing strips of baking plates of a baking machine. The laser arrangement has a laser source for outputting a laser beam onto a locally selectable target area by continuous variation of the output direction of the laser beam and traversing a contour forming the target area. Deflecting optics are arranged at a distance from the laser source and in the target area of the laser source for deflecting the laser beam and for projecting the target area formed by the contour onto the baking plate to be cleaned along a projection direction. The deflecting optics has a device for adjustment for varying the projection direction and the outlet direction of the laser beam.

The invention relates to an arrangement for cleaning baking surfaces, in particular for cleaning surfaces of baking plates, baking moulds or baking rings, for example, to produce flat wafers, hollow wafers, rolled cones, soft waffles, wafer rolls, wafer tubes etc. The invention further relates to an arrangement of a baking machine to produce baked products which has one or more baking surface(s) and having at least one arrangement for cleaning the baking surface(s).

Baking machines such as, for example wafer baking machines for the industrial production of wafers comprise an oven section in which openable and closable baking tongs are guided in a circumferentially driven manner. The dough to be baked or the baking mass to be baked is introduced between the two baking plates of the baking tongs and baked under the action of temperature and optionally pressure. After the baking process, the baking tongs are opened and the ready-baked wafer can be removed.

In practice, the problem arises that residues remain on the baking surfaces of the baking plates coming in contact with the dough or the baking mass. These residues contain, for example, oils, fats, starch-containing deposits, sugar deposits etc. In order to remove these deposits from the baking surface and clean these, different methods are used at the present time.

For example, baking tongs are opened individually in a cleaning mode of the baking machine and brushed by manual brushing. Another possibility corresponding to the prior art is blowing off the baking surfaces with compressed air which however only eliminates loose baking waste and not encrusted material.

During the cleaning of baking surfaces, there is a conflict of aims between thorough cleaning and gentle treatment of the baking surfaces. For example, when brushing out the baking surfaces it can occur that the surface is roughened or damaged. On the other hand, in the case of gentle treatment of the baking surface in many cases it is not possible to remove encrusted material or contaminants.

Laser cleaning systems are known to solve this conflict of aims, which can be retro-fitted to existing installations and can be supplied as a modular device if required or designed as an integral component of the baking machine. This laser cleaning system must be configured in such a manner that an interface for connection to the baking machine is provided and that the laser arrangement is coupled to the baking machine mechanically and/or in terms of control technology.

Such a design is known, for example, from WO 2014/020117. The present invention is in particular a further development of a device disclosed in this publication.

For cleaning baking plates having a baking surface configured in a relief-like manner or having laterally running sealing strips, it can be advantageous if the angle at which the laser radiation is incident on the surface to be cleaned is variable. According to the prior art, devices are known in which the laser head is rotatable about two axes so that the emission angle of the laser can be selected. A disadvantage with these designs is that the components for rotation of the laser head enlarge the device with the result that it is not possible to insert it between the baking plates of an only partially opened baking tong. However, the complete opening of a baking plate for cleaning however requires an adaptation of a baking machine which in practice can also lead to problems.

It is now the object of the invention to overcome the disadvantages of the prior art. This optionally comprises the fact that a laser arrangement is created which is suitable for the cleaning of baking plates of a baking tong, wherein the baking tongs must only be opened as far as corresponds to normal operation of the baking apparatus. Furthermore, it is an object of the invention to enable a cleaning of baking plates which have baking surfaces configured in a relief-like manner and/or also sealing strips or evaporation strips.

The object according to the invention is solved in particular by the features of the independent patent claims.

Optionally the invention relates to a laser arrangement for cleaning baking surfaces configured in a relief-like manner and optionally for cleaning evaporation or sealing strips of baking plates of a baking machine, comprising a laser source for output of a laser beam onto a locally selectable target area by continuous variation of the output direction of the laser beam and traversing a contour forming the target area, a deflecting optics arranged at a distance from the laser source and in the target area of the laser source for deflecting the laser beam and for projecting the target area formed by the contour onto the baking plate to be cleaned along a projection direction.

Optionally it is provided that the deflecting optics has a means for adjustment for varying the projection direction and the outlet direction of the laser beam.

Optionally it is provided that that the deflecting optics has at least two deflecting elements which deflect laser beams emanating from the laser source at different angles or that the deflecting optics has at least two deflecting elements configured as reflection elements such as in particular as mirrors, which are arranged at different angles with respect to the laser source or that the deflecting optics has at least one deflecting element for deflecting the laser beam, which has at least two selectable positions, so that at least two selectable different projection directions are provided.

Optionally it is provided that the deflecting optics or its deflecting element(s) is or are arranged movably, and/or that the deflecting optics or the deflecting element(s) thereof is or are arranged twistably, pivotably or rotatably about an axis of rotation, wherein the axis of rotation approximately corresponds to the central output direction of the laser beam from the laser source.

Optionally it is provided that a carrier element which projects from a base body and which is in particular configured to be tubular is provided, that the deflecting optics is provided in the area of the free end of the carrier element and in particular is firmly connected to the carrier element.

Optionally it is provided that the carrier element is arranged movably by means of a carrier element drive, rotatably or rotatably about the axis of rotation.

Optionally it is provided that the carrier element drive and/or the laser source are arranged in the area of the base body or on the base body.

Optionally it is provided that the target area of the laser source is directed as desired onto one of the deflecting elements or onto one of the deflecting elements configured as reflection element.

Optionally it is provided that that the target area and the contour forming the target area are configured to be strip-shaped or linear or that the target area and the contour forming the target area are configured to be strip-shaped or linear and are traversed in an oscillating manner or repeatedly by the laser beam.

Optionally it is provided that a control cam is provided which is scanned by a scanning element to activate or to deactivate the laser source and that the scanning element will be or is moved with respect to the control cam by actuation of the carrier element drive and optionally by rotation of the carrier element and that the laser source is thereby activated or deactivated depending on the projection direction.

Optionally it is provided that a suction unit is provided, the suction line of which projects into that region in which the laser beam emerges or on which the laser beam is incident on the object to be cleaned.

Optionally it is provided that a movement device for the translational movement of the carrier element or the deflecting optics is provided, wherein the direction of the translational movement in particular follows the central output direction of the laser beam from the laser source, the course of the carrier element or the axis of rotation, and wherein optionally a second direction of the translational movement is provided which runs substantially transversely to the first direction and in particular runs vertically.

Optionally it is provided that the laser arrangement is configured as a module which can be connected or is connected to a baking machine.

Optionally the invention relates to an arrangement comprising a baking device with an endless conveyor, wherein baking tongs are arranged on the endless conveyor, wherein the baking tongs each comprise a lower plate and an upper plate connected pivotably to the lower plate, wherein the baking tongs are each conveyed successively along the endless conveyor: from a loading device for application of a baking mass into an opened baking tong, to a device for closing the baking tong, through a heated baking chamber, further to a device for opening the baking tong, and then to a product removal device for removing the baked products from the baking tong, wherein a laser arrangement according to the invention is provided.

Optionally it is provided that a device for opening the baking tong and a device for closing the baking tong are provided and that the baking tongs are opened between the two devices by an opening angle, and that the deflecting optics and at least a part of the carrier element project laterally, i.e. transversely to the direction of movement of the endless conveyor into the baking tong and between the upper plate and the lower plate.

Optionally it is provided that the projection direction is directed by turning the deflecting optics or by turning the carrier element connected to the deflecting optics as desired onto the upper plate from inside or onto the lower plate from inside.

Optionally it is provided that the angle of incidence of the projection device onto the baking tong can be varied by optionally directing the target area of the laser source onto one of the deflecting elements or onto one of the reflection elements.

Optionally it is provided that the deflecting optics comprises at least two deflecting elements, that the target area of the laser source is optionally directed onto one of the two deflecting elements, that when the target area of the laser source is directed onto the one deflecting element, the projection direction has a first angle of incidence on the baking plate to be cleaned, that when the target area of the laser source is directed onto the other deflecting element, the projection direction has a second angle of incidence on the baking plate to be cleaned, and that the two angles of incidence deviate in opposite directions from an angle of incidence incident perpendicularly on the baking plate.

Optionally it is provided that the deflecting optics has at least three reflection elements, that the target area of the laser source is directed as desired onto one of the three reflection elements, that when the target area of the laser source is directed onto the one reflection element, the projection direction has a first angle of incidence on the baking plate to be cleaned, that when the target area of the laser source is directed onto another reflection element, the projection direction has a second angle of incidence on the baking plate to be cleaned, that the two angles of incidence deviate in opposite directions from an angle of incidence incident perpendicularly on the baking plate, and that when the target area of the laser source is directed onto a third reflection element, the projection direction has a third angle of incidence on the baking plate to be cleaned, which lies between the first and the second angle of incidence and in particular runs substantially perpendicular to the baking plate to be cleaned.

For cleaning the baking surfaces, the laser arrangement or the arrangement preferably comprises several degrees of freedom. The laser radiation emerging from the laser arrangement along a projection direction can optionally be varied by pivoting or rotating the deflecting optics. The angular variation is thereby accomplished preferably substantially in a normal plane of the axis of rotation of this movement. This axis of rotation is optionally arranged in a normal plane of the direction of movement of the baking tongs through the endless conveyor. In particular, this axis of rotation and optionally also the carrier element run transversely to the direction of movement of the baking tongs and preferably laterally into the opened baking tongs.

A further relative movement can be accomplished by a movement of the baking tongs itself. If the laser arrangement is held substantially in a fixed position, wherein the projection direction is directed onto a baking surface of the baking tong, and if the endless conveyor of the baking device is subsequently activated, a strip of the baking tong can be cleaned. If the endless conveyor is moved further, a strip of several or all the baking plates covered by the laser beam can be cleaned. In order to now extend the cleaning area, the deflecting optics or the emerging laser radiation can optionally also be moved translationally by a movement device. This translational movement or the direction thereof preferably runs transversely to the conveying direction of the baking tongs along the endless conveyor and in particular along the axis of rotation of the laser arrangement.

In all embodiments, the laser source can be configured in such a manner that a laser beam can be output in different or in selectable directions. Lasers of this type are known for example as marking lasers for marking or lettering objects made of steel, plastic or other materials. Laser sources of this type are usually compact modules which can be controlled via a program interface or control interface so that the laser beam is delivered in the desired direction.

According to a preferred embodiment, the laser source is arranged on a base body. Optionally the laser source or the base body with a carrier element can be arranged movably, in particular translationally.

According to a preferred embodiment, the output direction of the laser source runs substantially horizontally or inclined. A deflecting optics is provided in order to now deflect the laser radiation onto the baking plate to be cleaned. This deflecting optics can, for example, comprise deflecting elements such as mirrors, reflection elements, or other optical elements which are suitable for deflecting a laser beam.

Preferably the deflecting optics comprises a means for adjustment for varying the projection direction and the outlet angle of the laser beam. By this means for adjustment, a laser beam emerging from the laser source can be deflected at different angles. This means for adjustment can, for example, be a movable deflecting element such as for example a mirror. According to a preferred embodiment, the deflecting optics comprises a plurality of deflecting elements. The laser source is adapted or suitable for directing a laser beam as desired onto at least one of the deflecting elements. As a result of the different configuration of the deflecting elements, for example, by arranging the reflection elements at different angles, the outlet angle of the laser beam can be varied according to the choice of deflecting element.

For efficient cleaning of baking surfaces and the sealing strips, it can be advantageous if the laser beam cleans the largest possible area in the shortest possible time. For this reason, the laser beam is preferably not guided statically, in a punctuate manner onto the baking surface to be cleaned but directed onto a selectable target area. This target area is in particular formed by a contour which is traversed by the laser beam. In this case, the contour can be traversed periodically or in an oscillating manner. Optionally the contour can be traversed recurrently or repeatedly. As a result of the rapid traverse of the target area, the range of action of the laser is increased. According to a preferred embodiment, the target area is configured to be substantially strip-shaped or linear. This target area can preferably be directed onto one of the deflecting elements as desired so that the target area is deflected and projected onto the baking surface. This target area is projected along a projection direction. This projection direction can now be varied by the means for adjustment of the deflecting optics.

In particular for cleaning the laterally arranged evaporation or sealing strips, it is advantageous if the projection direction deviates from the perpendicular direction. As a result, internal corners can also be efficiently cleaned.

According to a preferred embodiment, the deflecting optics is substantially passive and comprises mirrors connected substantially rigidly to the carrier element. The carrier element can, for example, be configured as a projecting carrier element. In particular, the carrier element can also be configured to be tubular and comprise the deflecting optics at its free end. As a result of this configuration, the free end of the carrier element can be configured to be space-saving whereby the laser arrangement can be introduced between baking plates opened at an acute angle. In particular, it is advantageous if the baking plates must only have those opening angles which they have during conventional operation of the baking machine. This angle is, for example, between 30° and 60°, in particular about 35° to 40°.

As a result of the additional rotatability of the deflecting optics, the projection direction can be rotated or moved by a further degree of freedom. As a result, for example even box-shaped baking plates having sealing strips and/or evaporation strips can be cleaned. Furthermore, the rotatability brings about the advantageous effect that the projection direction or the laser radiation can be directed from the lower baking plate onto the upper baking plate or from the upper baking plate onto the lower baking plate by actuating the carrier element drive. The cleaning of the upper baking plate and the lower baking plate preferably takes place in the same way.

In order to avoid laser radiation emerging between the baking plates during rotation of the projection direction, optionally a control cam and a scanning element are provided. These elements are configured in such a manner that the laser source is deactivated when the projection direction is not directed onto any baking plate.

Alternatively or additionally, the deflecting optics can also be configured in such a manner that the projection direction can be adjusted not only in a plane running parallel to a sealing or evaporation strip but obliquely to the course of a sealing or evaporation strip so that a box-shaped baking plate can be cleaned merely by the deflecting optics.

An exemplary method for cleaning baking surface configured in a relief-like manner and evaporation or sealing strips of baking plates can, for example, comprise one or more of the following steps:

In a first step, the baking device can be put into a cleaning mode in which no batter is poured on. In a further step the laser arrangement can be activated. The laser arrangement can, for example, be configured as a module which can be docked or is docked onto the baking device. Preferably the laser arrangement is docked onto the baking device in the area of the pre-head of the baking device. In this area the baking tongs are opened during normal operation for pouring on dough and for product removal. In the cleaning mode on the other hand, the laser arrangement projects between the baking plates to perform the cleaning. In a laser arrangement having a modular configuration, accordingly a connection to the baking device must possibly first be made. In particular, the connection is made mechanically and/or by control technology.

In a further step, the laser source is activated so that laser radiation of the laser source is output into a target area. The deflecting optics is arranged in this target area, by means of which the laser radiation is deflected and in particular deflected onto one of the two baking plates of the baking tong. In order to now clean one region or the entire baking plate, a degree of freedom of the laser arrangement can be used to guide the laser beam over the entire baking plate.

Optionally the endless conveyor of the baking device is actuated to bring about a relative movement between the laser beam and the baking plates. According to a preferred embodiment, the baking tongs are moved along the endless conveyor wherein the laser arrangement in a first step remains substantially unmoved so that a strip of all the baking tongs is cleaned. In a second step the laser arrangement or the laser beam is moved translationally, transversely to the conveying direction of the baking plates so that a second strip of all the baking tongs running parallel to the first strip is cleaned.

This process can be repeated so frequently until all the lower plates and/or all the upper plates are cleaned.

In order to clean corners and edges of the evaporation or sealing strips and in particular in order to be able to clean the relief-like structure of baking tongs more efficiently, the angle of incidence of the projection direction can be adjusted. These different angles of incidence are brought about in particular by the means for adjustment of the deflecting optics. The different angles of incidence preferably lie in one plane which corresponds to a plane perpendicular to the conveying direction of the baking tongs.

When the lower plates are cleaned, the deflecting optics can be turned, for example, through 180° so that the laser beams are directed onto the upper baking plates. The cleaning of the upper plates, in particular the strip-shaped cleaning, can take place similarly to the cleaning of the lower plates.

Furthermore, the laser arrangement can comprise a suction unit which in particular can extract the combustion gases or flaking particles produced during cleaning.

The invention optionally relates to an arrangement with a baking device, wherein a laser arrangement is provided, wherein an interface for connection to the laser arrangement is provided, wherein the interface comprises a mechanical interface for coupling of the laser arrangement to the baking machine and/or a control interface for coupling of the control of the baking machine to the control of the laser arrangement, wherein the laser arrangement comprises a laser head from which laser radiation can be guided onto a processing area on the baking surface and that the laser head and the baking surface have at least one drivable degree of freedom relative to one another and/or wherein the baking surface and/or the laser head can be driven and moved by at least one drive.

Any form of laser arrangement can be used as the laser arrangement which is suitable for removing contaminants from the baking surface. Preferably used however are commercial industrial lasers such as in particular marking lasers. The laser treats by oscillation a for example 10 to about 120 mm wide strip of the baking surface, wherein the strip is preferably about 16 mm wide. Depending on the width of the strip it can be necessary that the baking surface is not cleaned in one but in several passes. If the width of the treatment area of the laser arrangement corresponds to the width of the baking plate, the treatment can take place in one step.

Preferably solid-state lasers or CO₂ lasers in pulsed or continuous mode are used. Examples of laser arrangements which can be used are a TEA CO₂ laser or a solid-state laser with a wavelength of 10.6 μm.

The laser power can be between 20 and 500 Watts. Preferably the power is about 100 to 200 Watts. Fibre lasers having a wavelength of 1.06 μm and a power of about 60 Watts have proved particularly advantageous in practice.

The laser power actually required is furthermore optionally dependent on the oscillation frequency, the oscillation amplitude, the type and degree of contamination.

The laser arrangement is optionally connected or coupled to a baking device. To this end both the baking machine and also the laser arrangement optionally have an interface. The interface can on the one hand be a control interface and on the other hand a mechanical interface. The control interface optionally connects the means for controlling the laser arrangement and the means for controlling the baking machine to a control unit. In this case, a single control unit can be suitable and/or adapted for controlling the laser arrangement and the baking machine or a control device for the laser arrangement and a control device for the baking machine can be provided in each case. For example, the speed of the moving baking surfaces can be varied for cleaning. Furthermore, the control of the laser arrangement can be made dependent on the degree of contamination and the speed of the baking surface. Thus for example, control parameters such as the laser power, the oscillation frequency or the oscillation amplitude can be varied by the connection via the interface.

The interface further optionally relates to the mechanical connection and/or coupling of the laser arrangement to the baking machine. This interface is given, for example, by conventional connecting means such as screws, bolts, clamping devices, guide means etc. In principle, any connecting means is suitable which can be used to produce an interface, in particular the desired positioning of the laser arrangement on the baking machine.

In the method according to the invention, a light beam having a high intensity, preferably a laser beam, is optionally guided onto the baking surface by the device according to the invention. The baking surfaces are preferably formed from a metallic body and have a smooth surface or predetermined pattern-like relief structure. When the laser beam is incident on the baking surface, a large proportion of the radiation is reflected. However, when the laser beam is incident on a contaminated location or a contaminant particle, the laser beam is absorbed by the contaminant. The energy is converted into thermal energy whereby the contaminant particle or the contaminated area is heated until combustion or evaporation takes place. As a result of the different absorption or reflection properties of the contaminants and the baking surfaces, a particularly efficient and gentle cleaning is possible. The cleaning process is therefore a substantially thermal process.

Since the laser beam of the laser source according to a preferred embodiment traverses a contour and in particular is output in an oscillating or moving manner, in particular the average output direction is specified to define the output directions or the course of the laser radiation. If the laser radiation is output for example in an oscillating manner along a strip-shaped or linear contour, the direct connection between laser source and the centre of the target area or the centre of the contour is defined as output direction or as average output direction. The target area is deflected by the deflecting optics or projected onto a baking surface. The projection direction is also defined as that direction which corresponds to the average direction of the laser radiation output in an oscillating or moving manner and deflected. The angle of incidence of the projection direction on the baking plate is therefore preferably also defined as the direction of incidence of the average radiation direction.

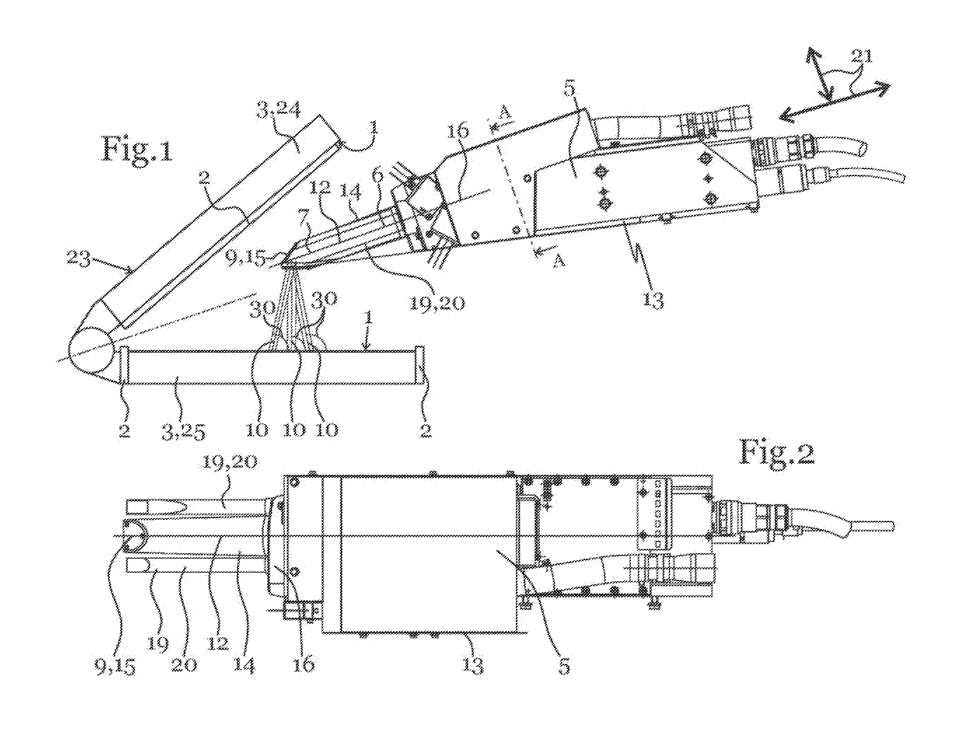

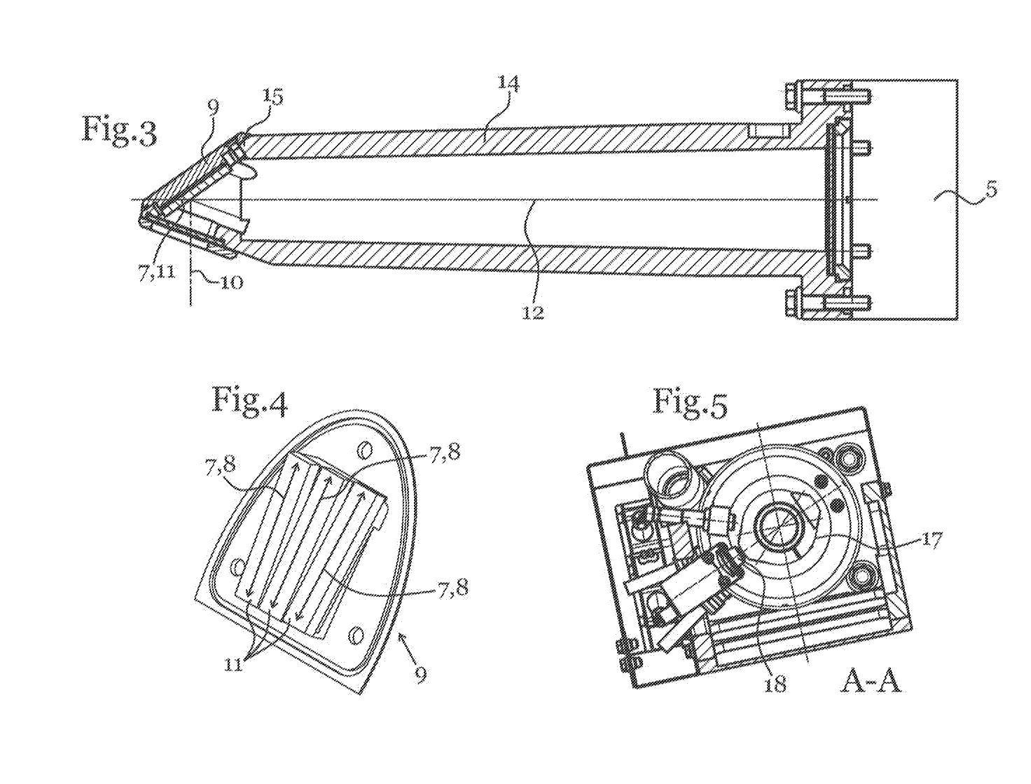

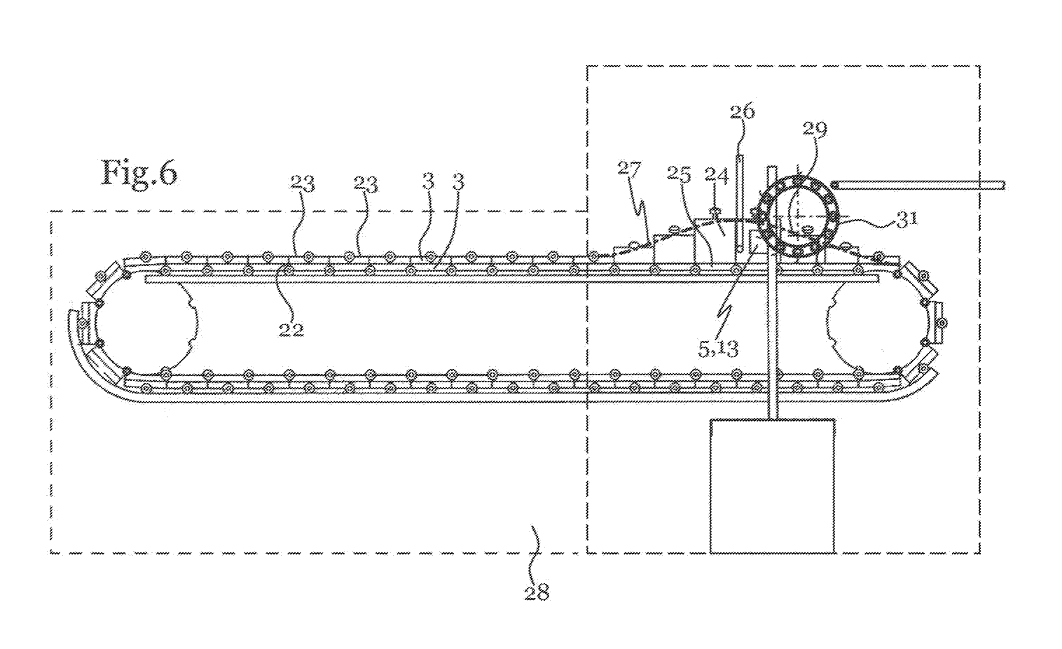

The invention is described further with reference to the figures, wherein FIG. 1 shows a schematic view of a baking tong and a part of a laser arrangement, FIG. 2 shows a top view of a part of a laser arrangement, FIG. 3 shows a section of the carrier element of an exemplary deflecting optics, FIG. 4 shows a schematic detailed view of a part of an exemplary deflecting optics, FIG. 5 shows a section with the control cam and a scanning element and FIG. 6 shows a schematic view of an arrangement with a baking device.

Unless specified otherwise, the reference numbers correspond to the following components: baking surface 1, sealing strip or evaporation strip 2, baking plate 3, baking machine 4, laser source 5, laser beam 6, target area 7, contour 8, deflecting optics 9, projection direction 10, deflecting element 11, axis of rotation (of the carrier element) 12, base body 13, carrier element 14, free end (of the carrier element) 15, carrier element drive 16, control cam 17, scanning element 18, suction unit 19, suction line 20, direction(s) (of the translational movement(s)) 21, endless conveyor 22, baking tong 23, upper plate 24, lower plate 25, loading device 26, device (for closing the baking tong) 27, baking chamber 28, device (for opening the baking tong) 29, angle of incidence 30, product removal device 31.

FIG. 1 shows a schematic view of at least a part of a laser arrangement and an arrangement comprising a baking device. Shown as an example of the baking device is a baking tong 23 which comprises two baking plates 3, namely an upper plate 24 and a lower plate 25. The two plates 24, 25 are connected to one another in a hinged manner and can thereby be opened or closed by a device (27, 29) for opening and for closing the baking tong 23.

Each baking plate 3 preferably comprises a baking surface 1. This baking surface 1 is the surface of the baking plate 3 with which the dough or the baking mass comes in contact and which can be cleaned by the arrangement according to the invention. Optionally the baking plate 3 comprises one or more sealing or evaporation strips 2. These evaporation or sealing strips 2 are used for sealing a baking mould formed by the baking plates 3 and optionally for retaining the baking mass during evaporation of the water component contained in the baking mass. The sealing or evaporation strips 2 optionally project beyond the baking surface 1 of the baking plate 3 whereby an angle is formed which can preferably be cleaned by the arrangement according to the invention.

The laser arrangement comprises a laser source 5 for outputting a laser beam 6 into a target area 7. A deflecting optics 9 is provided in the target area 7, which is adapted to deflect the laser beam 6 along several projection directions 10 onto the baking plate 3.

In particular, the laser arrangement comprises several degrees of freedom for varying the output direction or the projection direction 10 of the laser beam. The laser arrangement optionally comprises a carrier element 14 which in the present embodiment is configured to be substantially is tubular. A deflecting optics 9 is provided at the free end 15 of the carrier element 14. Optionally a carrier element drive 16 is provided for movement of the carrier element 14 and in particular for movement of the deflecting optics 9. In the present embodiment the carrier element drive 16 is a rotary drive for rotating the carrier element 14 about the axis of rotation 12.

Preferably the laser arrangement comprises a base body 13 which is arranged substantially rigidly or optionally movably. Optionally a suction unit 19 with a suction line 20 is provided for extraction of contaminant particles or gases.

The laser arrangement further comprises a device for translational movement along a direction 21 or along two translational directions. Optionally the direction 21 of the translational movement follows substantially the axis of rotation 12 or the course of the carrier element 14.

The projection direction 10 can be guided by the special configuration of the deflecting optics 9 in different angles of incidence 30 onto the baking surface 1. Preferably at least two different projection directions 10 can be achieved, wherein the two angles, starting from the deflecting optics 9, are preferably pivoted on both sides of an orthogonal direction. In the present embodiment, three different projection directions 10 or three different angles of incidence 30 of these projection directions 10 are depicted. The average projection direction 10 is substantially incident with a 90 degree angle of incidence 30 on the baking surface 1. The two other projection directions 10 are pivoted at different angles from this 90 degree angle of incidence 30. This ensures that the laser beams 6 of the laser source 5 can also penetrate into the corners of the sealing strips 2.

FIG. 2 shows a top view of the laser arrangement shown in FIG. 1 wherein the components described in FIG. 1 correspond to the components of FIG. 2.

According to the embodiment of FIG. 2, the suction unit 19 comprises two suction lines 20, wherein one of the suction lines 20 is directed onto the lower plate 25 and one of the suction lines 20 is directed onto the upper plate 24. The upper plate 24 or the lower plate 25 are treated depending on the rotational position or position of the deflecting optics 9 or according to the projection direction 10, wherein the respective suction unit 19 or the respective suction line 20 is used for extraction.

FIG. 3 shows a schematic sectional view of parts of a laser arrangement according to the invention. The carrier element 14 is configured to be substantially tubular and preferably closed tubular, wherein the deflecting optics 9 is provided in the region of the free end 15 of the carrier element 14. The deflecting optics 9 comprises in all embodiments optionally an output for exit of the laser radiation which is optionally closed by a transparent element such as, for example by a lens or a planar transparent window. The deflecting optics 9 comprises at least one deflecting element 11 which is provided in the target area 7 of the laser source 5 so that the laser beam 6 incident on the deflecting element 11 of the deflecting optics 9 is then deflected in the direction of the projection direction 10. The average direction of the output laser radiation can in all embodiments for example, as in the present case also, follow the axis of rotation 12 of the carrier element 14 or the course of the carrier element 14. Preferably the carrier element 14 or its free end 15 is designed to be convergent or substantially conical so that the laser arrangement can be introduced into the gusset formed by the baking tong.

Optionally in all embodiments a sealing, transparent window such as for example a glass window is also provided in the region of the transition between the laser source 5 and the carrier element 14 in order to spatially separate the inner region of the carrier element 14 from the laser source. Optionally in all embodiments optical elements such as deflecting elements or transparent windows comprise a cooling system, a flushing air arrangement or a sealing air arrangement.

FIG. 4 shows a schematic view of a part of a deflecting optics 9. The deflecting optics 9 comprises in the present embodiment three deflecting elements 11. These three deflecting elements 11 are rigidly connected at different angles to a base plate of the deflecting optics 9. According to a further embodiment, more or less deflecting elements 11 can be provided at different angles. According to a further embodiment not shown one or more deflecting elements can also be arranged movably in order to bring about different projection directions.

According to a preferred embodiment however, the deflecting elements 11 are connected substantially rigidly to the base plate. The laser beam 6 emerging from the laser source 5 is preferably directed into a target area 7. The target area 7 is preferably formed by a contour 8. The contour 8 is preferably traversed in a recurrent or oscillating manner. Thus, in the present case the target area 7 is configured to be substantially strip-shaped or linear. The contour 8 thus corresponds to this strip or this line. Preferably the target area 7 is directed as desired onto one of the deflecting elements 11. The laser beam 6 of the laser source 5 is therefore preferably directed onto only one contour 8 or one of the depicted target areas 7.

The projection direction 10 can be varied by the different angles of the deflecting element or elements 11. As a result of the strip-shaped or linear form of the target area 7, a form corresponding to this form is also projected onto the baking plate 3.

In the present form the deflecting elements 11 are configured as reflection elements or as mirrors. Optionally however other elements can also be used which are suitable for deflecting or projecting the target area 7 of the laser source 5 onto the baking surface 1. For example, prisms would be possible alternatives.

FIG. 5 shows a schematic sectional view of the sectional profile A-A from FIG. 1. The device comprises a control cam 17 and a scanning element 18. Rotation of the carrier element 14 or actuation of the carrier element drive 16 results in a relative movement of the control cam 17 with respect to the scanning element 18. The scanning element 18 is connected to the laser source 5 by control technology so that it can be activated or deactivated. By scanning the control cam 17, the laser source 5 can be deactivated when the projection direction is not directed onto a baking plate 3 or not onto a baking surface 1. On the other hand, the laser source 5 can be activated by the scanning element 18 combined with the control cam 17 when the projection direction 10 is directed onto the baking surface 1 to be cleaned.

FIG. 6 shows a schematic view of parts of an arrangement according to the invention comprising an endless conveyor 22 along the course of which a plurality of baking tongs 23 are arranged to be conveyed substantially along an upper and along a lower transport level. The baking tongs 23 each comprise two baking plates 3, namely an upper plate 24 and a lower plate 25. The baking device further comprises the following schematically depicted components: a loading device 26, a device 27 for closing the baking tongs, a device 29 for opening the baking tongs and a baking chamber 28.

The arrangement further comprises a laser source 5 which is part of the laser arrangement according to the invention.

As shown schematically in the present view of FIG. 6, the laser arrangement is configured as a module which is optionally firmly connected to the baking device or which can be supplied as required and connected to the baking machine. Preferably the connection is made or the laser arrangement is arranged in a region in which the baking tongs 23 of the baking device are opened, for example in the region of the loading device 26 or in the region of the product removal device 31 or between the loading device 26 and the product removal device 31. Conventional baking devices of the type mentioned initially open the baking tongs at an angle of about 30°-50°, in particular at about 35° to 40° efficient cleaning of the baking plates 3 by the configuration according to the invention is nevertheless possible. This is brought about in particular by the special configuration of the carrier element 14, the deflecting optics 9 and/or the laser arrangement.

Optionally the base body 13 is designed to be rigid or ground-standing and optionally fastened to a mobile carriage. Optionally the base body 13 is configured to be movable translationally, in particular movable translationally along the directions 21 and arranged on a floor-standing or fixedly arranged base frame.

1-18. (canceled)

19. A configuration, comprising:
a baking device with an endless conveyor;
a loading device;
a first device;
a heated baking chamber;
a second device;
a product removal device;
baking tongs disposed on said endless conveyor, said baking tongs each having evaporation and/or sealing strips and baking plates including a lower plate and an upper plate connected pivotably to said lower plate, said baking plates having baking surfaces, said baking tongs are each conveyed successively along said endless conveyor from said loading device for application of a baking mass into an opened baking tong, to said first device for closing a baking tong, through said heated baking chamber, further to said second device for opening said baking tong, and then to said product removal device for removing baked products from the baking tong;
a laser configuration for cleaning said baking surfaces configured in a relief-like manner and for cleaning said evaporation and/or sealing strips, said laser configuration including:
a laser source for outputting a laser beam onto a locally selectable target area by continuous variation of an output direction of the laser beam and traversing a contour defining the target area;
deflecting optics disposed at a distance from said laser source and in said target area of said laser source for deflecting the laser beam and for projection of the target area defined by the contour onto said baking plate to be cleaned along a projection direction; and
said deflecting optics having a device for adjustment for varying the projection direction and an outlet direction of said laser beam.

20. The configuration according to claim 19, wherein:
said deflecting optics have at least two deflecting elements which deflect laser beams emanating from said laser source at different angles; or
said deflecting optics have at least two deflecting elements configured as reflection elements, which are disposed at different angles with respect to said laser source; or
said deflecting optics have at least one deflecting element for deflecting the laser beam, which has at least two selectable positions;
so that at least two selectable different projection directions are provided.

21. The configuration according to claim 19, wherein:
said deflecting optics have at least one deflecting element;
said deflecting optics or said deflecting element is disposed movably; and/or
said deflecting optics or said deflecting element thereof is disposed twistably, pivotably or rotatably about an axis of rotation, wherein the axis of rotation approximately corresponds to a central output direction of the laser beam from said laser source.

22. The configuration according to claim 19, further comprising;
a base body; and
a carrier element projecting from said base body and configured to be tubular, said deflecting optics disposed in an area of a free end of said carrier element and connected to said carrier element.

23. The configuration according to claim 22, further comprising a carrier element drive, said carrier element is disposed movably by means of said carrier element drive, rotatably or rotatably about an axis of rotation.

24. The configuration according to claim 23, wherein said carrier element drive and/or said laser source are disposed in an area of said base body or on said base body.

25. The configuration according to claim 19, wherein:
said deflecting optics have deflecting elements; and
said target area of said laser source is directed as desired onto one of said deflecting elements or onto one of said deflecting elements configured as reflection elements.

26. The configuration according to claim 19, wherein:
said target area and said contour defining said target area are configured to be strip-shaped or linear; or
said target area and said contour defining said target area are configured to be strip-shaped or linear and are traversed in an oscillating manner or repeatedly by the laser beam.

27. The configuration according to claim 23, further comprising:
a scanning element; and
a control cam being scanned by said scanning element to activate or to deactivate said laser source, said scanning element is moved with respect to said control cam by actuation of said carrier element drive and by rotation of said carrier element, and said laser source is thereby activated or deactivated depending on the projection direction.

28. The configuration according to claim 19, further comprising a suction unit having a suction line projecting into that region in which the laser beam emerges or on which the laser beam is incident on an object to be cleaned.

29. The configuration according to claim 23, further comprising a movement device for a translational movement of said carrier element or said deflecting optics, wherein a first direction of the translational movement follows a central output direction of the laser beam from said laser source, a course of said carrier element or the axis of rotation, and wherein a second direction of the translational movement is provided which runs substantially transversely to the first direction and runs vertically.

30. The configuration according to claim 19, wherein the laser configuration is configured as a module which can be connected or is connected to a baking machine.

31. The configuration according to claim 22, wherein:
said baking tongs are opened between said first and second two devices by an opening angle; and
said deflecting optics and at least a part of said carrier element project laterally, namely transversely to a direction of movement of said endless conveyor into said baking tong and between said upper plate and said lower plate.

32. The configuration according to claim 22, wherein the projection direction is directed by turning said deflecting optics or by turning said carrier element connected to said deflecting optics as desired onto said upper plate from inside or onto said lower plate from inside.

33. The configuration according to claim 25, wherein an angle of incidence of the projection direction onto said baking tong can be varied by directing the target area of said laser source onto one of the deflecting elements or onto one of said reflection elements.

34. The configuration according to claim 19, wherein:
said deflecting optics have at least two deflecting elements;
the target area of said laser source is directed onto one of said two deflecting elements;
when the target area of said laser source is directed onto said one deflecting element, the projection direction has a first angle of incidence on said baking plate to be cleaned;
when the target area of said laser source is directed onto an other of said deflecting element, the projection direction has a second angle of incidence on said baking plate to be cleaned; and
the first and second angles of incidence deviate in opposite directions from an angle of incidence incident perpendicularly on said baking plate.

35. The configuration according to claim 19, wherein:
said deflecting optics has at least three reflection elements;
the target area of said laser source is directed as desired onto a first of said three reflection elements;
when the target area of said laser source is directed onto said first reflection element, the projection direction has a first angle of incidence on said baking plate to be cleaned;
when the target area of said laser source is directed onto a second of said reflection elements, the projection direction has a second angle of incidence on said baking plate to be cleaned;
the first and second angles of incidence deviate in opposite directions from an angle of incidence incident perpendicularly on said baking plate; and
when the target area of said laser source is directed onto a third of said reflection elements, the projection direction has a third angle of incidence on said baking plate to be cleaned, which lies between the first and the second angle of incidence and runs substantially perpendicular to said baking plate to be cleaned.
